(19) United States
(12) Patent Application Publication
(10) Pub. No.: US 2018/0012627 A1
(43) Pub. Date: Jan. 11, 2018

(54) MANAGING FAR AND NEAR TRACK ERASURE BY DYNAMIC CONTROL OF A WRITE CURRENT PARAMETER OF A MAGNETIC DISK DRIVE

(71) Applicant: HGST Netherlands B.V., Amsterdam (NL)

(72) Inventors: Mark Hutcheson Burkhardt, San Jose, CA (US); Venkatesh Chembrolu, San Jose, CA (US); Zhaohui Chen, San Jose, CA (US); Quan-Chiu Lam, San Jose, CA (US); Supradeep Narayana, Santa Clara, CA (US)

(21) Appl. No.: 15/204,827

(22) Filed: Jul. 7, 2016

(51) Int. Cl. G11B 20/10; G11B 5/09

(52) U.S. Cl. CPC G11B 20/10212; G11B 5/09

(57) ABSTRACT

A method may include causing a write head of a magnetic data storage drive to write a first portion of data to a magnetic data storage device of the magnetic data storage drive based at least in part on a first value of at least one parameter of a write current. The method may include updating a value of a write counter and determining whether the value of the write counter is greater than or equal to a threshold write count. The method may also include adjusting the at least one parameter of the write current to a second, different value. The method may further include causing the write head to write a second portion of data to the magnetic data storage device based at least in part on the second value of the at least one parameter of the write current.

### TECHNICAL FIELD

The disclosure relates to managing write current parameters for magnetic data storage drives.

### BACKGROUND

Hard disk drives (HDDs) store data in annular tracks in magnetic storage media. One way to increase HDD capacity is to increase the track density by reducing the track width, or reducing the spacing between tracks. However, increased track density may increase the risk of near track erasure (NTE) and far track erasure (FTE). NTE and FTE may occur when the magnetic field produced by the write head interferences with the nearby data tracks, causing the recorded data to become corrupt or even erased.

### SUMMARY

In one example, the disclosure is directed to a method may include causing, by a controller of a magnetic data storage drive, a write head of the magnetic data storage drive to write a first portion of data to a magnetic data storage device of the magnetic data storage drive based at least in part on a first value of at least one parameter of a write current. The method may include, in response to writing the first portion, updating, by the controller, a value of a write counter, and determining, by the controller, whether the value of the write counter is greater than or equal to a threshold write count. The method may also include, in response to determining that the value of the write counter is greater than or equal the threshold write count, adjusting, by the controller, the at least one parameter of the write current to a second, different value. The method may further include causing, by the controller, the write head to write a second portion of data to the magnetic data storage device based at least in part on the second value of the at least one parameter of the write current.

In another example, the disclosure is directed to a magnetic data storage drive that may include a write head, a magnetic data storage device, and a controller. The controller may be configured to cause the write head to write a first portion of data to the magnetic data storage device based at least in part on a first value of at least one parameter of a write current. The controller may also be configured to, in response to writing the first portion, update a value of a write counter, and determine whether the value of the write counter is greater than or equal to a threshold write count. The controller may also be configured to, in response to determining that the value of the write counter is greater than or equal the threshold write count, adjust the at least one parameter of the write current to a second, different value. The controller may be further configured to cause the write head to write a second portion of data to the magnetic data storage device based at least in part on the second value of the at least one parameter of the write current.

In another example, the disclosure is directed to a magnetic data storage drive that includes means for causing a write head of the magnetic data storage drive to write a first portion of data to a magnetic data storage device of the magnetic data storage drive based at least in part on a first value of at least one parameter of a write current. The magnetic data storage drive may include, in response to writing the first portion, means for updating, by the controller, a value of a write counter, and means for determining whether the value of the write counter is greater than or equal to a threshold write count. The magnetic data storage drive may also include, in response to determining that the value of the write counter is greater than or equal the threshold write count, means for adjusting the at least one parameter of the write current to a second, different value. The magnetic data storage drive may further include means for causing the write head to write a second portion of data to the magnetic data storage device based at least in part on the second value of the at least one parameter of the write current.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment in which a magnetic data storage drive may function as a storage device for a host device, in accordance with one or more techniques of this disclosure.

FIG. 2 is a block diagram illustrating the controller and other components of the magnetic data storage drive of FIG. 1 in more detail.

FIGS. 3A-3B are graphs illustrating example write currents, in accordance with one or more techniques of this disclosure.

FIG. 4 is a graph illustrating example measurement results of a technique for adjusting at least one parameter of a write current, in accordance with one or more aspect of this disclosure.

FIG. 5 is a graph illustrating example measurement results of a technique for adjusting at least one parameter of a write current, in accordance with one or more aspect of this disclosure.

FIG. 6 is a flow diagram illustrating an example method for adjusting at least one parameter of a write current, in accordance with one or more techniques of this disclosure.

### DETAILED DESCRIPTION

In general, this disclosure describes techniques for adjusting at least one parameter of a write current that is applied to a write head of a magnetic data storage drive, such as a hard disk drive (HDD), while writing data. A HDD may include magnetic media including a plurality of rotating disks (or “platters”) that each include a plurality of annular magnetic tracks. A write head writes data to a particular track of a disk by applying a time-varying magnetic field to the particular track as the disk rotates. A controller may provide the parameters of a write current to a preamplifier. Based on the parameters received from the controller, the preamplifier may generate a write current which causes the write head to apply the time-varying magnetic field to the particular data track. The controller may also maintain a write counter to track the number of write cycles. As the number of write cycles increase the interference of the magnetic field from the head causing inference with the nearby tracks (e.g., near tracks and far tracks) grows with each write cycle. The risk of erasure is reduced when the interference between the magnetic field, generated for recording on the data track, and the nearby tracks is reduced. The controller may compare the value of the write counter to a threshold write count value. If the value of the write counter is greater than or equal to the threshold write count value, the controller may adjust a parameter of the write current to reduce the risk of the magnetic field generated by the write current affecting nearby tracks. By adjusting at least one parameter of the write current, the controller may reduce the risk of corrupting data stored at a data track near the particular data track being written by the write head.

In some examples, at least one parameter of the write current may include a rise time, a steady state current, an overshoot current, or any combination thereof. For example, the controller may increase the duration of the rise time if the value of the write counter is greater than a threshold write count value. Similarly, the controller may increase a steady state component of the write current and may decrease the overshoot current component of the write current if the value of the write counter is greater than a threshold write count value. By increasing the rise time duration, the controller may reduce the risk that the magnetic field generated by the write current will affect nearby tracks. By increasing the steady state component of the write current and decreasing the overshoot component of the write current, the controller may reduce or substantially minimize the reduction in the write performance that may be caused by a reduce rise time.

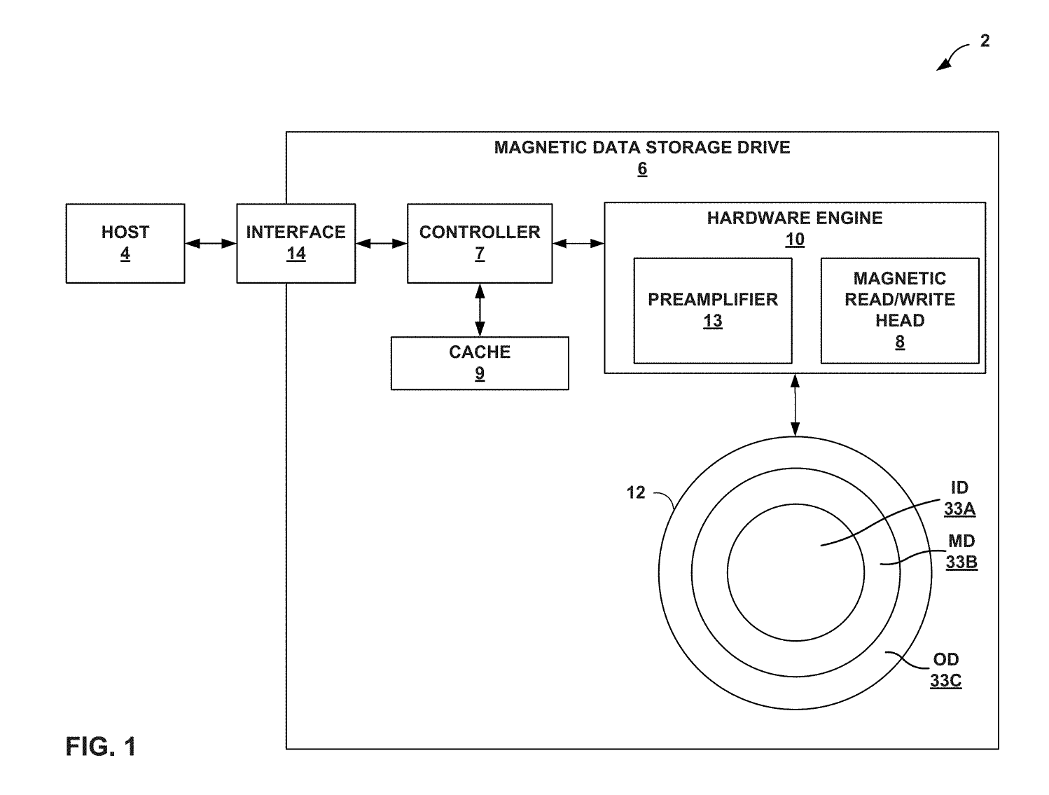

FIG. 1 is a conceptual and schematic block diagram illustrating an example storage environment 2 in which magnetic data storage drive 6 may function as a storage device for host device 4, in accordance with one or more techniques of this disclosure. For instance, host device 4 may utilize non-volatile memory devices included in magnetic data storage drive 6 to store and retrieve data. In some examples, storage environment 2 may include a plurality of storage devices, such as magnetic data storage drive 6, that may operate as a storage array. For instance, storage environment 2 may include a plurality of magnetic data storage drives 6 configured as a redundant array of inexpensive/independent disks (RAID) that collectively function as a mass storage device for host device 4. While techniques of this disclosure generally refer to storage environment 2 and magnetic data storage drive 6, techniques described herein may be performed in any storage environment that utilizes magnetic recording. In some examples, magnetic data storage drive 6 may include HDD, a tape drive, or the like.

Storage environment 2 may include host device 4 which may store and/or retrieve data to and/or from one or more storage devices, such as magnetic data storage drive 6. As illustrated in FIG. 1, host device 4 may communicate with magnetic data storage drive 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Typically, host device 4 comprises any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware or the like. For the purpose of executing techniques of this disclosure, host device 4 may send data to controller 7 via interface 14 such that magnetic read/write head 8 may write data to one or more data tracks, or host device 4 may receive data stored at one or more data tracks from controller 7 that were read by magnetic read/write head 8.

As illustrated in FIG. 1, magnetic data storage drive 6 may include controller 7, cache 9, hardware engine 10, interface 14, and one or more magnetic data storage devices 12. In some examples, magnetic data storage drive 6 may include additional components not shown in FIG. 1 for ease of illustration purposes. For example, magnetic data storage drive 6 may include power delivery components, motor, spindle, voice-coil and supporting electronics. In some examples, the physical dimensions and connector configurations of magnetic data storage drive 6 may conform to one or more standard form factors. Some example standard form factors include, but are not limited to, 3.5″ hard disk drive (HDD), 2.5″ HDD, or 1.8″ HDD.

Magnetic data storage drive 6 may include interface 14 for interfacing with host device 4. Interface 14 may include one or both of a data bus for exchanging data with host device 4 and a control bus for exchanging commands with host device 4. Interface 14 may operate in accordance with any suitable protocol.

Magnetic data storage drive 6 includes one or more magnetic data storage devices 12. Magnetic data storage devices 12 each may include a plurality of regions, such as Inner Disk (ID) region 33A, Middle Disk (MD) region 33B, and Outer Disk (OD) region 33C (collectively, regions 33). Each region 33 may include a plurality of concentric data tracks. For purposes of illustration only, three regions 33 are illustrated in FIG. 1. However, magnetic data storage drive 12 may include additional or fewer regions 33. Although not shown in FIG. 1, each of magnetic data storage devices 12 may be divided into a plurality of sectors. A sector may be the smallest unit of each of magnetic data storage devices 12 that is independently addressable by controller 7.

In the example of FIG. 1, magnetic data storage drive 6 includes hardware engine 10, which may represent the hardware responsible for interfacing with the magnetic data storage devices 12. Hardware engine 10 may, in the context of a platter-based magnetic data storage drive, represent magnetic read/write head 8, preamplifier 13, and the accompanying hardware to configure, drive, and process the signals sensed by and output by magnetic read/write head 8.

Magnetic data storage drive 6 also includes magnetic read/write head 8 and preamplifier 13. Magnetic read/write head 8 may be a device that transforms a physical magnetic flux into an electrical signal indicative of abstract bits, and vice versa. In other words, magnetic read/write head 8 may be operable by controller 7 to physically read the data in magnetic data storage devices 12 and convert the physical magnetic flux into an electrical signal indicative of abstract bits usable by host device 4. In some examples, magnetic read/write head 8 may convert a write current into a magnetic field to write data to magnetic data storage devices 12. Magnetic read/write head 8 may be carried by an arm and mechanically positioned over one or more of the plurality of data tracks by an actuator that rotates the arm about a pivot under control of controller 7. In some examples, magnetic read/write head 8 may be controlled by controller 7 to read data from and write data to particular sectors associated with a selected data track.

Preamplifier 13 may communicate signals between magnetic read/write head 8 and controller 7. For example, during a read operation, preamplifier 13 may amplify signals received from magnetic read/write head 8 before sending the signals to controller 7. As another example, preamplifier 13 may receive a signal from controller 7 and may generate a write current based on the received signal. Preamplifier 13 may output the write current to magnetic read/write head 8, which may cause magnetic read/write head 8 to output a magnetic field and write bits of data on to a rotating disk of magnetic data storage device 12.

Magnetic data storage drive 6 includes controller 7, which may manage one or more operations of magnetic data storage drive 6, including the techniques disclosed herein. Controller 7 may interface with host device 4 via interface 14 and manage the storage of data to and the retrieval of data from magnetic data storage devices 12 accessible via hardware engine 10. Controller 7 may perform operations described herein using software, hardware, firmware, or a mixture of both hardware, software, and firmware residing in and/or executing on magnetic data storage drive 6.

Controller 7 may receive a write command including data from host device 4. In some examples, in response to receiving the write command, controller 7 may determine one or more parameters of a write current that is to be generated by preamplifier 13. The one or more write current parameters may include a rise time, steady state current level, overshoot current level, or any combination thereof. In some examples, the one or more parameters may be based on a write counter. For instance, controller 7 may determine whether a value of the write counter satisfies (e.g., is greater than or equal to) a threshold write count value. In response to determining that the value of the write counter satisfies the threshold write count value, controller 7 may adjust at least one of the one or more of the write current parameters from a first value to a second, different value. In some examples, in response to determining the write current parameters, controller 7 may send the write current parameters to hardware engine 10.

In other examples, in response to receiving the write command, controller 7 may determine that the value of the write counter satisfies the threshold write count value. In response to determining that the value of the write counter satisfies the threshold write count value, controller 7 may send, to hardware engine 10, the data and an indication (e.g., a unique ID, label, or the like) of a set of write current parameters. For example, hardware engine 10 may store one or more sets of write current parameters and may select a particular set of write current parameters based on the received indication. Hardware engine 10 may adjust at least one of the one or more write current parameters from a first value to a second, different value by selecting a particular set of write current parameters where at least one of the write current parameter values is different than the previous value.

In still other examples, in response to receiving the write command, controller 7 may send the data and an indication of the write counter value to hardware engine 10. Hardware engine 10 may compare the value of the write counter to a threshold write current value. In response to determining that the value of the write counter satisfies a threshold write count value, hardware engine 10 may adjust at least one of the one or more write current parameters from a first value to a second, different value.

In some examples, controller 7 or hardware engine 10 may adjust a write current parameter by increasing the duration of the rise time. Increasing the duration of the rise time reduces the rate of excitation of the magnetic read/write head, which generates the magnetic field for writing data, which may reduce the interference of magnetic field with the nearby tracks and lower the risk of erasure.

In this manner, controller 7 or hardware engine 10 may adjust one or more parameters of a write current. By maintaining a write counter that counts the number of write cycles in a write operation, magnetic data storage drive 6 may dynamically adjust one or more write current parameters as the number of write cycles increases. By adjusting one or more write current parameters, magnetic data storage drive 6 may reduce the risk of near track erasure and far track erasure when writing data to a particular data track. By enabling data storage drive 6 to dynamically adjust the write current parameters, the described techniques may enable magnetic data storage drive 6 to utilize a rise time with a shorter duration and a low steady state current when the value of the write count is low (e.g., below a threshold value). When the duration of the rise time is low, magnetic data storage drive 6 may write data to magnetic data storage devices 12 more quickly. A low steady state current may reduce the energy consumed by magnetic data storage drive 6. However, if the duration of the rise time remains constant as the number of write cycles increases, the risk of affecting nearby tracks also increases. In some examples, increasing the rise time alone may result in the degradation of the write performance. As a result, in some examples, the write current parameters are adjusted, for example—increasing either the steady state current, overshoot current, or both, along with the increase of rise time to compensate in a manner that will not cause a significant change in write performance. Increasing the steady state current will increase the power consumption. As a result, in order to keep power consumption low, the controller may initially set the steady state current at a low value and may dynamically adjust the steady state current as number of write cycles increases. In other words, the described techniques may reduce the risk of affecting data tracks near the data track being written by the write head while reducing the effects on power consumption and maintaining steady write performance.

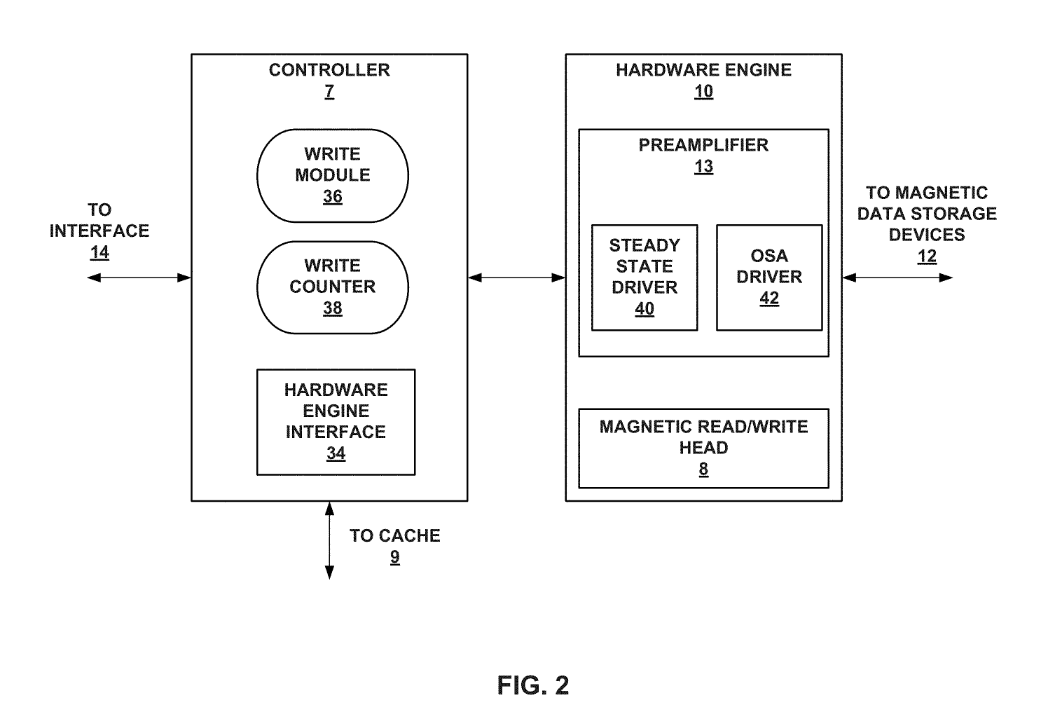

FIG. 2 is a block diagram illustrating controller 7 and other components of magnetic data storage drive 6 of FIG. 1 in more detail. In the example of FIG. 2, controller 7 includes hardware engine interface 34, write module 36, and write counter 38. Controller 7 may perform operations described herein using software, hardware, firmware, or a mixture of two or more of hardware, software, and firmware residing in and/or executing on magnetic data storage device 6. In some examples, controller 7 may be separate from hardware engine 10. In other examples, controller 7 may include functionality of hardware engine 10.

Write module 36 may manage write operations performed by hardware engine 10. For example, write module 36 may receive a write command including data from host device 4. In response to receiving the write command, write module 36 may initialize a write operation and may set a value of write counter 38 to a default value (e.g., zero). In some examples, the value of write counter 38 may be set to a default value upon completion of a previous write operation. Write counter 38 may track the number of write cycles during a write operation. A write cycle may refer to writing a portion of data received from host device 4 (e.g., a sector, bit, or other unit of data) to magnetic data storage devices 12.

In response to initializing the write operation, write module 36 send a first portion of the data received from host device 4 and one or more write current parameters to hardware engine 10 in order to cause magnetic read/write head 8 to write the first portion of data to magnetic data storage devices 12. Write module 36 may determine the one or more write current parameters based on the value of write counter 38. For example, write module 36 may compare the value of write counter 38 to a first threshold write count value (e.g., one thousand, two thousand, five thousand, or the like). For instance, if write module 36 recently received the write command such that none of the data received from host device 4 has been written to magnetic data storage devices 12, write module 36 may determine that the value of write counter 38 equals zero and is less than the first threshold write count value. In response to determining that the value of write counter 38 is less than the first threshold write count value, write module 36 may determine that the write current parameters should be set to default parameters. In other words, the rise time, steady state current component of the write current, and the overshoot current component of the write current may be set to default values. Write module 36 may send the first portion of the received data (e.g., a sector, a bit, or the like) and one or more initial (e.g., default) write current parameters to hardware engine 10 in order to cause magnetic read/write head 8 to write the first portion of data to magnetic data storage devices 12.

Preamplifier 13 may receive the first portion of data and the one or more initial write parameters and may generate a write current based on the received data and the value of the at least one write current parameters. For example, if the one or more initial write current parameters includes a default rise time, preamplifier 13 may generate a write current in which the duration of the rise time is set to a first, default duration. Rise time may refer to the amount of time taken by preamplifier 13 to increase the write current from a baseline current value to a peak write current value. In some examples, preamplifier 13 may include a steady state driver 40 and an overshoot amplitude (OSA) driver 42. Steady state driver 40 may generate a steady state current based on the steady state current parameter. OSA driver 42 may generate an overshoot current based on the overshoot current parameter. If the one or more initial write current parameters includes a default steady state current or default overshoot current, steady state driver 40 may generate a steady state current at a first, default steady state current level, OSA driver 42 may generate an overshoot current at a first, default overshoot current level, or both. Preamplifier 13 may output, to magnetic read/write head 8, the write current based on the rise time, the steady state current, and the overshoot current.

Magnetic read/write head 8 may generate a magnetic field as the write current passes through magnetic read/write head 8. The magnetic field causes the first portion of data to be stored to magnetic data storage devices 12. In response to writing the first portion of data to magnetic data storage devices 12, controller 7 may determine that the first write cycle is complete and may update the value of write counter 38. For example, controller 7 may increase the value of write counter 38 from zero to one.

In some examples, write module 36 may determine that a second portion of the data received from host device 4 should be written to data storage devices 12 and may determine whether to adjust one or more of the at least one write current parameters. Write module 36 may adjust at least one of the one or more write current parameters based on the value of write counter 38. For example, write module 36 may determine whether the value of the write counter is greater than or equal to a first threshold write count value (e.g., one thousand, two thousand, five thousand, six thousand, thirty thousand, or the like). For instance, if the first threshold write count value equals 1,000 and magnetic read/write head 8 has completed 1,000 write cycles, such that the value of the write counter equals 1,000, write module 36 may determine that the value of the write counter is greater than or equal to the first threshold write count value.

In response to determining that the value of the write counter is greater than or equal to the first threshold write count value, write module 36 may adjust at least one of the one or more write current parameters from a first value to a second, different value. For example, write module 36 may increase the duration of the rise time from a first duration (e.g., 100 picoseconds) to a second, greater duration (e.g., 150 picoseconds). Likewise, in some examples, write module 36 may increase the steady state current component of the write current from a first steady state current level (e.g., 35 mA) to a second, greater steady state current level (e.g., 40 mA). Similarly, in some examples, write module 36 may decrease the overshoot current component of the write current from a first overshoot current level (e.g., 45 mA) to a second, lower overshoot current level (e.g., 40 mA).

Write module 36 may send the second portion of data and at least one adjusted write current parameter to hardware engine 10. Preamplifier 13 of hardware engine 10 may receive the adjusted write current parameter and may generate a write current based on the second portion of data and the second value of the at least one adjusted write current parameter. Magnetic read/write head 8 may receive the write current from preamplifier 13 and may write the second portion of data to magnetic data storage devices 12 based on the write current. In response to writing the second portion of the data to magnetic data storage devices 12, write module 36 may update the value of write counter 38 (e.g., increasing the value of write counter 38 from 1,000 to 1,001).

In some examples, write module 36 may determine that a third portion of the received data should be written to magnetic data storage devices 12 and may determine whether to adjust at least one of the one or more write current parameters based on write counter 38. For example, write module 36 may determine whether the value of the write counter is greater than or equal to a second threshold write count value (e.g., two thousand, three thousand, five thousand, six thousand, thirty thousand, or the like) that is different than the first threshold write count value. For instance, if the second threshold write count value equals 5,000 and the value of the write counter equals 5,000, write module 36 may determine that the value of the write counter is greater than or equal to the second threshold write count value and may adjust at least one of the one or more write current parameters to a third value that is different than the first value and the second value. For example, write module 36 may increase the rise time from a second duration to a third duration, increase the steady state current from a second steady state current level to a third steady state current level, decrease the overshoot current from a second overshoot current level to a third overshoot current level, or any combination therein. Write module 26 may not compare the value of write counter 38 to a second threshold write count in all examples.

In some examples, the amount of change from the first value of a particular write current parameter to the second value of the particular write current parameter may be equal to the amount of change from the second value to the third value of the particular write current parameter. In other words, write current module 36 may change the value of the write current parameter in equal amounts. For example, if the particular write current parameter is the rise time, the first rise time may equal four nanoseconds, the second rise time may equal six nanoseconds, and the third rise time may equal eight nanoseconds. Thus, in this example, write module 36 may change the rise time in equal amounts (e.g., two nanoseconds). Likewise, in some examples, write module 36 may increase the steady state current in equal amounts or decrease the overshoot current in equal amounts.

In other examples, the amount of change from the first value of a particular write current parameter to the second value of the particular write current parameter may be different than the amount of change from the second value to the third value of the particular write current parameter. In other words, write current module 36 may change the value of the particular write current parameter in different amounts. For example, if the particular write current parameter is the rise time, the first rise time may equal two nanoseconds, the second rise time may equal four nanoseconds, and the third rise time may equal eight nanoseconds. Thus, in this example, the first change in the rise time equals two nanoseconds and the second change in the rise time equals four nanoseconds. Similarly, in some examples, write module 36 may increase the steady state current in different amounts or decrease the overshoot current in different amounts. In some examples, the amount of change from the second value to the third value of the particular write current parameter may be an integer multiple (e.g., 2×, 3×, 4×, or the like) of the amount of change from the first value to the second value of the particular write current parameter.

In response to adjusting at least one of the one or more write current parameters, write module 36 may send a third portion of the data and the at least one adjusted write current parameter to preamplifier 13. Preamplifier 13 may generate a write current based on the received third portion of data and the third value of at least one adjusted write current parameter. For example, steady state driver 40 may generate a steady state current based on a second steady state current level, OSA driver 42 may generate an overshoot current based on a second overshoot current level. Preamplifier 13 may cause the write current to reach a peak current level over a second rise time duration. Preamplifier 13 may output the write current to magnetic read/write head 8 and magnetic read/write head 8 may generate a magnetic field in response to the write current in order to write the third portion of the data to magnetic data storage devices 12. In response to causing hardware engine 10 to write the third portion of the data, write module 36 may update the value of the write counter.

In some examples, write module 36 may determine that a fourth portion of the received data should be written to magnetic data storage devices 12 and may determine whether to adjust at least one of the one or more write current parameters based on write counter 38. Write module 36 may compare the value of the write counter 38 to a third threshold write count value. In some examples, the threshold write count values may be linearly related. For example, the first threshold write count value may equal one thousand, the second threshold write count value may equal two thousand, and the third threshold write count value may equal three thousand. In other words, if the threshold write count values are linearly related, the difference between the first and second threshold write count values may be equal to the difference between the second and third write count values. In some examples, the threshold write count values may not be linearly related. For example, the first threshold write count value may equal one thousand, the second threshold write count value may equal three thousand, and the third threshold write count value may equal six thousand. As another example, the first threshold write count value may equal one thousand, the second threshold write count value may equal five thousand, and the third threshold write count value may equal thirty thousand. In other words, if the threshold write count values are not linearly related, the difference between the first and second threshold write count values is not equal to the difference between the second and third write count values.

In response to determining that the value of the write counter is greater than or equal to the third threshold write count value, write module 36 may adjust at least one of the one or more write parameters. For example, write module 36 may increase the duration of the rise time from a third duration to a fourth, greater duration, increase the steady state current from a third steady state current level to a fourth, greater steady state current level, decrease the overshoot current level from a third overshoot current level to a fourth, lower overshoot current level, or any combination therein.

In response to adjusting at least one of the one or more write current parameters, write module 36 may send a fourth portion of data and the adjusted parameters to hardware engine 10. Preamplifier 13 may generate a write current based on the fourth value of the at least one adjusted write current parameter, and magnetic read/write head 8 may generate a magnetic field based on the write current in order to write the fourth portion of the data to magnetic data storage devices 12. In some examples, in response to writing the fourth portion of the data, write module 36 may determine that all of the data received from host device 4 has been written to magnetic data storage devices 12. As a result, in some examples, write module 36 may reset the value of write counter 38 to a baseline value (e.g., zero).

In some examples, controller 7 may maintain a respective write counter associated with each data storage device of magnetic data storage devices 12. In some examples, controller 7 may maintain a respective write counter associated with each region 33 of each magnetic data storage device 12. For example, controller 7 may maintain a respective write counter for inner disk (ID) region 33A, middle disk (MD) region 33B, and outer disk (OD) region 33C associated with each data storage device 12. If some data is to be stored at a first region (e.g., ID region 33A) and the value of the write counter associated with ID region 33A is greater than or equal to a threshold write count value, controller 7 may adjust at least one of the parameters of the write current sent to magnetic read/write head 8 when writing data to ID region 33A. However, if some data is to be stored at a second region (e.g., MD region 33B) and the value of the write counter associated with MD region 33B is not greater than or equal to a threshold write count value, controller 7 may refrain from adjusting any of the parameters of the write current sent to magnetic read/write head 8 when writing data to ID region 33B. In some examples, controller 7 may maintain a respective write counter associated with each data track of each magnetic data storage device 12. In these examples, controller 7 may adjust at least one of the write current parameters for a particular data track if the write counter associated with the particular data track is greater than or equal to a threshold write count value, and may refrain from adjusting any of the write current parameters associated with a different data track if the write counter associated with the different track is not greater than or equal to a threshold write count value.

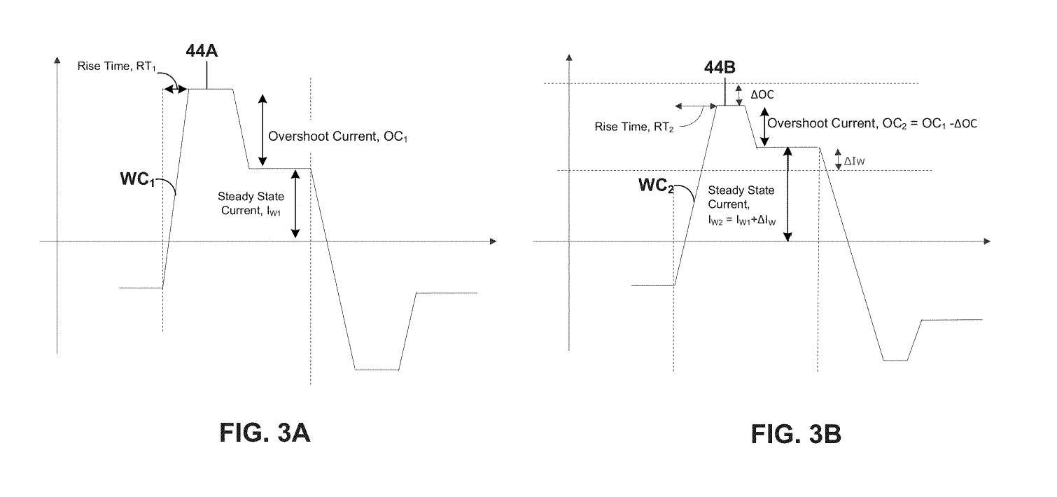

FIGS. 3A-3B are graphs illustrating example write currents, in accordance with one or more techniques of this disclosure. For ease of illustration, the exemplary techniques of FIGS. 3A-3B will be described with concurrent reference to magnetic data storage drive 6 and controller 7 of FIGS. 1 and 2. However, the techniques may be used with any combination of hardware or software.

Controller 7 may receive a write command including data from host device 4. Write module 36 may send a first portion of the data and one or more initial write current parameters to preamplifier 13. As illustrated in FIG. 3A, the one or more initial write current parameters may include a first rise time RT₁, first steady state current IW₁, first overshoot current OC₁, or any combination therein. Preamplifier 13 may generate a first write current WC₁ based on the values of the initial write current parameters. Magnetic read/write head 8 may receive the first write current WC₁ and may generate a magnetic field based on the first write current WC₁ in order to write a first portion data to magnetic data storage devices 12. In response to writing the first portion of the data to magnetic data storage devices 12, write module 36 may update write counter 38 to indicate that a first write cycle has been completed.

In some examples, write module 36 may compare the value of write counter 38 to a threshold write count value in order to determine whether the value of write counter 38 is greater than or equal to the threshold write count value. In response to determining that the value of write counter 38 is greater than or equal to a threshold write count value, write module 36 may adjust at least one of the write current parameters. In other words, write module 36 may adjust at least one of the steady state current, overshoot current, or rise time. For example, as shown in FIG. 3A, first rise time RT₁ illustrates the duration of time used to increase write current WC₁ from a baseline current value to peak write current 44A. Write module 36 may increase the duration of the rise time such that the duration of time used to increase WC₂ from a baseline current value to peak write current 44B includes second rise time RT₂, as shown in FIG. 3B.

In some examples, write module 36 may increase the steady state current from a first steady state current level I_{W1} to a second steady state current level I_{W2}, as shown in FIG. 3B. The difference between the first steady state current I_{W1} and the second steady state current I_{W2} equals the change ΔI_{W} in the steady state current. Write module 36 may decrease the overshoot current from a first overshoot current level OC₁ to a second overshoot current level OC₂, as also shown in FIG. 3B. The difference between the first overshoot current value OC₁ to a second overshoot current value OC₂ equals the change in the steady state current ΔOC. In some examples, the change ΔI_{W} in the steady state current may be inversely proportional to the change ΔOC in the overshoot current. For example, write module 36 may increase the steady state current by approximately 5% to approximately 10% of the first steady state current I_{W1} and may decrease the overshoot current by approximately 5% to approximately 10% of the first overshoot current OC₁. In some examples, the peak write current 44A of first write current WC₁ may equal the peak write current 44B of second write current WC₂. However, in some examples, as illustrated in FIG. 3B, the peak write current 44A of first write current WC₁ may be different than the peak write current 44B of second write current WC₂.

Write module 36 may send a second portion of the data received from host device 4 and the at least one adjusted write current parameter to hardware engine 10. Responsive to receiving the second portion of data and the at least one adjusted write current parameter, preamplifier 13 may generate second write current WC₂ using the adjusted write current parameters. Magnetic read/write head 8 may receive the second write current WC₂ and generate a magnetic field based on the second write current WC₂ in order to write the data to magnetic data storage devices 12.

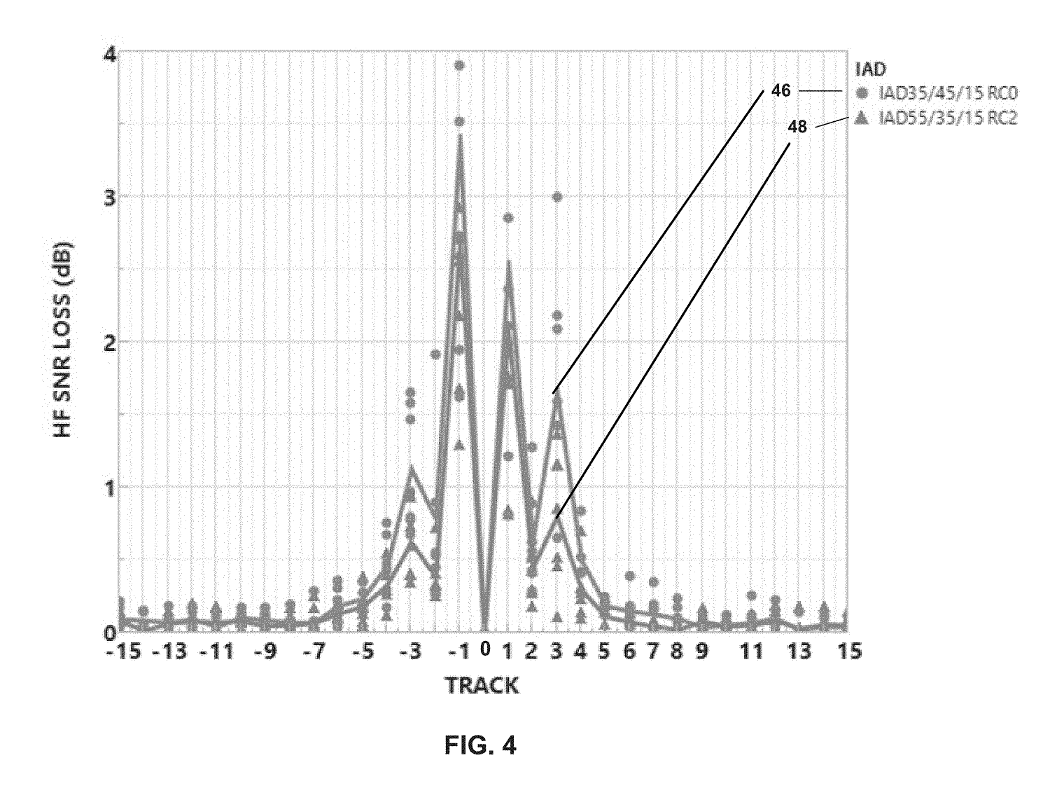

FIG. 4 is a graph illustrating example experimentally measured results of a technique for adjusting at least one parameter of a write current, in accordance with one or more aspect of this disclosure. The Y-axis shows the signal to noise ratio (SNR) loss for two different sets of write current parameters. The X-axis shows a number of data tracks of a magnetic data storage device. For example, track 0 indicates the track to which data is being written, tracks “−1” to “−15” indicate tracks to one side of track 0 and tracks “1” to “15” indicate tracks to the other side of track 0.

The signal profile represented by mean fit lines 46 and 48 shows actual experimental SNR loss measurements after ten thousand (10 k) write cycles for different write current parameters. The SNR loss on the nearby track is indicative of the risk of erasure on these tracks. Line 46 shows actual experimental SNR loss measurements when the write current parameters (rise time, steady state current, and overshoot current) are at one value. In particular, data points 46 illustrate the SNR loss when the duration of the rise time is approximately 300 picoseconds, the steady state current equals 35 milliamps, the overshoot current equals 45 milliamps and the duration of the overshoot current equals 15 nanoseconds. Line 48 shows actual experimental SNR loss measurements after the write current parameters have been adjusted. In particular, data points 46 illustrate the SNR loss when the duration of the rise time is increased from approximately 300 picoseconds to approximately 330 picoseconds, the steady state current is increased to 55 milliamps, the overshoot current is decreased to 35 milliamps, and the duration of the overshoot current equals 15 nanoseconds. As shown by FIG. 4, after ten thousand write cycles, the SNR loss is lower for data points 48 than for data points 46. In other words, increasing the rise time and steady state current and decreasing the overshoot current results in a lower erasure as measured here by SNR loss.

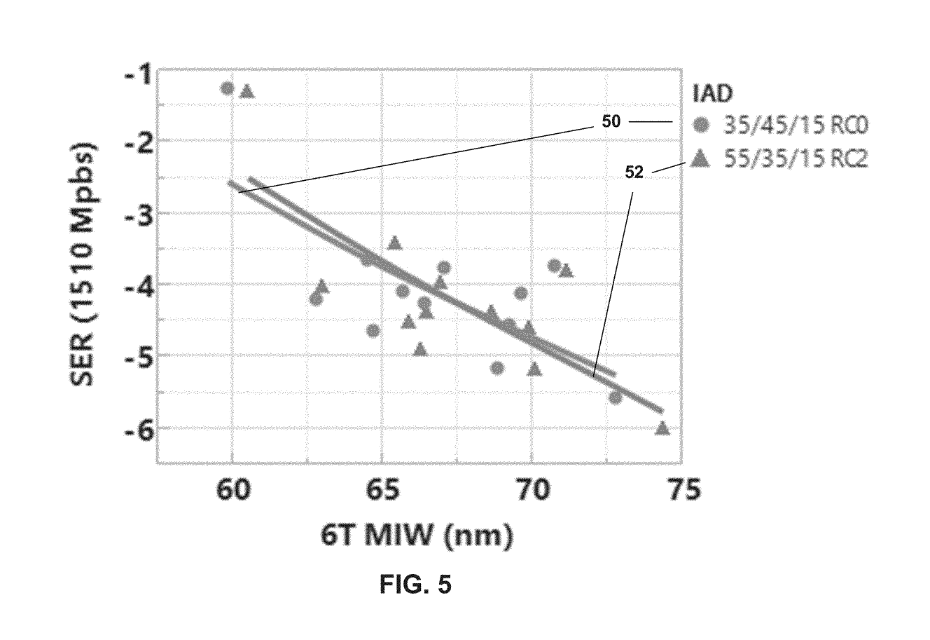

FIG. 5 is a graph illustrating example measurement results of a technique for adjusting at least one parameter of a write current, in accordance with one or more aspect of this disclosure. The X-axis is the magnetic interference width for each sample tested represented by a dot. The Y-axis shows the soft error ratio (SER) for two different sets of write current parameters.

The line 50 is a regression fit for the actual experimental SER measurements when the write current parameters (rise time, steady state current, and overshoot current) are at an initial value. In particular, line 50 illustrates the SER when the duration of the rise time is approximately 300 picoseconds, the steady state current equals 35 milliamps, the overshoot current equals 45 milliamps, and the duration of the overshoot current equals 15 nanoseconds. The line 52 is a regression fit showing actual experimental SER measurements after the write current parameters have been adjusted. In particular, line 52 illustrates the SER when the duration of the rise time is increased from approximately 300 picoseconds to approximately 330 picoseconds, the steady state current is increased to 55 milliamps, the overshoot current is decreased to 35 milliamps, and the duration of the overshoot current equals 15 nanoseconds. As shown by FIG. 5, the SER for data points that are fitted into lines 50 and 52 is similar. In other words, increasing the rise time and steady state current and decreasing the overshoot current results in a similar overall performance.

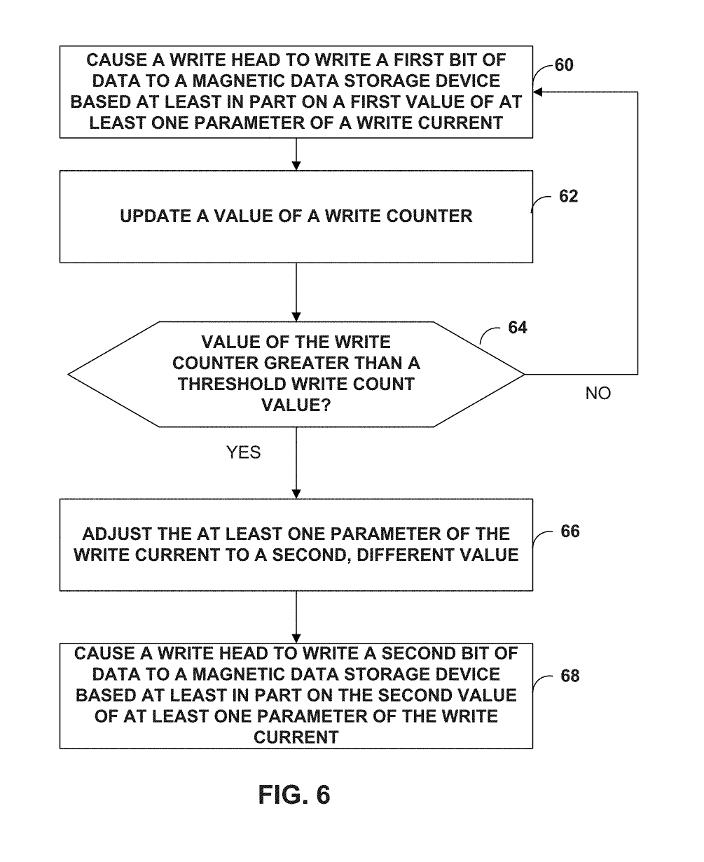

FIG. 6 is a flow diagram illustrating an example method for adjusting at least one parameter of a write current, in accordance with one or more techniques of this disclosure. For ease of illustration, the exemplary method of FIG. 6 will be described with concurrent reference to magnetic data storage drive 6 and controller 7 of FIGS. 1 and 2. However, the techniques may be used with any combination of hardware or software.

In some examples, controller 7 may cause magnetic read/write head 8 to write a first portion of data to magnetic data storage device 12 based at least in part on a first value of at least one parameter of a write current (60). The at least one parameter of the write current may include a rise time of the write current, a steady state current component of the write current, an overshoot current component of the write current, or any combination thereof. In some examples, the first value of the at least one parameter of the write current may be a default value. In some examples, the default value may include a preset value (e.g., a preset rise time, a preset steady state current, and/or a preset overshoot current).

In response to writing the first portion of data, in some examples, controller 7 may update a value of a write counter (62). For example, controller 7 may increase the value of the write counter by one increment per write cycle (e.g., from zero to one) to indicate that a first write cycle is complete. In some examples, controller 7 may determine that a second portion of data remains to be written to data storage devices 12 and may determine whether to adjust at least one parameter of the write current based on the value of the write counter. Controller 7 may determine whether the value of the write counter is greater than or equal to a threshold write count value (64). For example, controller 7 may compare the value of the write counter to a threshold write count value in order to determine whether the write count value is greater than or equal to the threshold value.

In some example, controller 7 may compare the value of the write counter more than one threshold write count value. For example, controller 7 may include a first threshold write count value (e.g., one thousand), a second threshold write count value (e.g., five thousand), and a third threshold write count value (e.g., thirty thousand). In response to determining that the value of the write counter is not greater than or equal the threshold write count (64, NO path), controller 7 may return to operation (60) and may cause magnetic read/write head 8 to write another portion of data to magnetic data storage devices 12 using the first value of the at least one parameter of the write current.

In response to determining that the value of the write counter is greater than or equal the threshold write count (64, Yes path), controller 7 may adjust the at least one parameter of the write current to a second, different value (66). For example, controller 7 may increase the rise time from a first duration to a second, greater duration. Similarly, in some examples, controller 7 may increase the steady state current from a first steady state current level to a second, greater steady state current level. Likewise, in some examples, controller 7 may decrease the overshoot current from a first overshoot current level to a second, lower overshoot current level.

Controller 7 may cause the write head to write a second bit of data to the magnetic data storage device based at least in part on the second value of the at least one parameter of the write current (68). For example, controller 7 may send the second value of the at least one write current parameter to hardware engine 10. Preamplifier 13 may receive the second value of the at least one write current parameter and may generate a write current using the second value of the at least one write current parameter. Magnetic read/write head 8 may receive the write current and generate a magnetic field based on the write current in order to write the second bit.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
causing, by a controller of a magnetic data storage drive, a write head of the magnetic data storage drive to write a first portion of data to a magnetic data storage device of the magnetic data storage drive based at least in part on a first value of at least one parameter of a write current;
in response to writing the first portion, updating, by the controller, a value of a write counter;
determining, by the controller, whether the value of the write counter is greater than or equal to a threshold write count;
in response to determining that the value of the write counter is greater than or equal the threshold write count, adjusting, by the controller, the at least one parameter of the write current to a second, different value; and
causing, by the controller, the write head to write a second portion of data to the magnetic data storage device based at least in part on the second value of the at least one parameter of the write current.

2. The method of claim 1, wherein adjusting the at least one parameter of the write current to the second, different value comprises adjusting, by the controller, a rise time from a first duration to a second, different duration.

3. The method of claim 1, wherein adjusting the at least one parameter of the write current to the second, different value comprises adjusting, by the controller, a steady state current component of the write current from a first steady state current level to a second, different steady state current level.

4. The method of claim 1, wherein adjusting the at least one parameter of the write current to the second, different value comprises adjusting, by the controller, an overshoot current component of the write current from a first overshoot current level to a second, different overshoot current level.

5. The method of claim 1, wherein adjusting the at least one parameter of the write current to the second, different value comprises:
increasing, by the controller, a steady state current component of the write current from a first steady state current level to a second, greater steady state current level;
decreasing, by the controller, an overshoot current component of the write current from a first overshoot current level to a second, lower overshoot current level; and
increasing, by the controller, the rise time from a first rise time duration to a second, greater rise time duration.

6. The method of claim 1, wherein the threshold write count is a first threshold write count, the method further comprising:
in response to writing the second portion of data to the magnetic data storage device, updating, by the controller, the value of the write counter;
determining, by the controller, whether the value of the write counter is greater than or equal to a second threshold write count, wherein the second threshold write count is greater than the first threshold write count;
in response to determining that the value of the write counter is greater than or equal the second threshold write count, adjusting, by the controller, at least one parameter of the write current to a third, different value; and
causing, by the controller, the write head to write a third portion of data to the magnetic data storage device based at least in part on the third value of the at least one parameter of the write current.

7. The method of claim 6, wherein:
adjusting at least one parameter of the write current to the second, different value comprises adjusting a particular parameter by a first amount,
adjusting at least one parameter of the write current to the third, different value comprises adjusting the particular parameter by a second amount, and
the first amount is different than the second amount.

8. The method of claim 6, further comprising:
in response to writing a third portion of data to the magnetic data storage drive, updating, by the controller, the value of the write counter;
determining, by the controller, whether the value of the write counter is greater than or equal to a third threshold write count, wherein the third threshold write count is greater than the first threshold write count and the second threshold write count, and wherein the first threshold write count, second threshold write count, and third threshold write count are not linearly related;
in response to determining that the value of the write counter is greater than or equal the third threshold write count, adjusting, by the controller, at least one parameter of the write current to a fourth, different value; and
causing, by the controller, the write head to write a fourth portion of data to the magnetic data storage device based at least in part on the fourth value of the at least one parameter of the write current.

9. The method of claim 1, wherein the write counter is associated with a particular track of the magnetic data storage drive.

10. A magnetic data storage drive comprising:
a write head;
a magnetic data storage device; and
a controller configured to:
cause the write head to write a first portion of data to the magnetic data storage device based at least in part on a first value of at least one parameter of a write current;
in response to writing the first portion, update a value of a write counter;
determine whether the value of the write counter is greater than or equal to a threshold write count;
in response to determining that the value of the write counter is greater than or equal the threshold write count, adjust the at least one parameter of the write current to a second, different value; and
cause the write head to write a second portion of data to the magnetic data storage device based at least in part on the second value of the at least one parameter of the write current.

11. The magnetic data storage drive of claim 10, wherein the controller is further configured to adjust the at least one parameter of the write current to the second, different value by adjusting a rise time from a first duration to a second, greater duration.

12. The magnetic data storage drive of claim 10, wherein the controller is further configured to adjust the at least one parameter of the write current to the second, different value by adjusting a steady state current component of the write current from a first steady state current level to a second, greater steady state current level.

13. The magnetic data storage drive of claim 10, wherein the controller is further configured to adjust the at least one parameter of the write current to the second, different value by adjusting an overshoot current component of the write current from a first overshoot current level to a second, lower overshoot current level.

14. The magnetic data storage drive of claim 10, wherein the controller is further configured to adjust the at least one parameter of the write current to the second, different value by:
increasing a steady state current component of the write current from a first steady state current level to a second, greater steady state current level;
decreasing an overshoot current component of the write current from a first overshoot current level to a second, lower overshoot current level; and
increasing the rise time from a first rise time duration to a second, greater rise time duration.

15. The magnetic data storage drive of claim 10, wherein the threshold write count is a first threshold write count, and wherein the controller is further configured to:
in response to writing the second portion of data to the magnetic data storage device, update the value of the write counter;
determine whether the value of the write counter is greater than or equal to a second threshold write count, wherein the second threshold write count is greater than the first threshold write count;
in response to determining that the value of the write counter is greater than or equal the second threshold write count, adjust at least one parameter of the write current to a third, different value; and
cause the write head to write a third portion of data to the magnetic data storage device based at least in part on the third value of the at least one parameter of the write current.

16. The magnetic data storage drive of claim 15, wherein:
adjusting at least one parameter of the write current to the second, different value comprises adjusting a particular parameter by a first amount,
adjusting at least one parameter of the write current to the third, different value comprises adjusting the particular parameter by a second amount, and
the first amount is different than the second amount.

17. The magnetic data storage drive of claim 15, wherein the controller is further configured to:
in response to writing a third portion of data to the magnetic data storage drive, update the value of the write counter;
determine whether the value of the write counter is greater than or equal to a third threshold write count, wherein the third threshold write count is greater than the first threshold write count and the second threshold write count, and wherein the first threshold write count, second threshold write count, and third threshold write count are not linearly related;
in response to determining that the value of the write counter is greater than or equal the third threshold write count, adjust at least one parameter of the write current to a fourth, different value; and
cause the write head to write a fourth portion of data to the magnetic data storage device based at least in part on the fourth value of the at least one parameter of the write current.

18. A magnetic data storage drive comprising:
means for causing a write head of the magnetic data storage drive to write a first portion of data to a magnetic data storage device of the magnetic data storage drive based at least in part on a first value of at least one parameter of a write current;
in response to writing the first portion, means for updating a value of a write counter;
means for determining whether the value of the write counter is greater than or equal to a threshold write count;
in response to determining that the value of the write counter is greater than or equal the threshold write count, means for adjusting the at least one parameter of the write current to a second, different value; and
means for causing the write head to write a second portion of data to the magnetic data storage device based at least in part on the second value of the at least one parameter of the write current.

19. The magnetic data storage drive of claim 18, wherein the means for adjusting the at least one parameter of the write current to the second, different value comprises:
means for increasing a steady state current component of the write current from a first steady state current level to a second, greater steady state current level;
means for decreasing an overshoot current component of the write current from a first overshoot current level to a second, lower overshoot current level; and
means for increasing the rise time from a first rise time duration to a second, greater rise time duration.

20. The magnetic data storage drive of claim 18, wherein the threshold write count is a first threshold write count, the magnetic data storage drive further comprising:
in response to writing the second portion of data to the magnetic data storage device, means for updating the value of the write counter;
means for determining whether the value of the write counter is greater than or equal to a second threshold write count, wherein the second threshold write count is greater than the first threshold write count;
in response to determining that the value of the write counter is greater than or equal the second threshold write count, means for adjusting at least one parameter of the write current to a third, different value; and
means for causing the write head to write a third portion of data to the magnetic data storage device based at least in part on the third value of the at least one parameter of the write current.
